(19) United States
(12) Patent Application Publication
(10) Pub. No.: US 2024/0060018 A1
(43) Pub. Date: Feb. 22, 2024

(54) DETERGENT COMPOSITIONS

(71) Applicant: CONOPCO, INC., D/B/A UNILEVER, Englewood Cliffs, NJ (US)

(72) Inventors: Matthew Lloyd Parry, Merseyside (GB); Matthew Rhys Thomas, Merseyside (GB)

(21) Appl. No.: 18/266,686

(22) PCT Filed: Dec. 6, 2021
(86) PCT No.: PCT/EP2021/084347

§ 371 Date: Jun. 12, 2023

(30) Foreign Application Priority Data
Dec. 16, 2020 (EP) 20214715.3

(51) Int. Cl. C11D 11/00; C11D 3/22

(52) U.S. Cl. CPC C11D 11/0094; C11D 11/0017; C11D 11/0023; C11D 3/22

(57) ABSTRACT

A liquid detergent composition comprising an external structuring system for liquid and gel-form laundry detergents comprising by weight percentage (a) from about 2 to about 10 percent of crystals of a glyceride, preferably hydrogenated castor oil, having a melting temperature of from 40 degrees centigrade to 100 degrees C., wherein at least one ingredient is derived from carbon capture. Also a method of making a liquid detergent composition comprising an external structuring system (ESS) comprising by weight percentage (a) from about 2 to about 10 percent of crystals of a glyceride, preferably hydrogenated castor oil, having a melting temperature of from 40 degrees centigrade to 100 degrees C. said method comprising the steps of:
a. providing a C1 carbon feedstock
b. transformation of said C1 carbon feedstock to provide a short chain intermediate having a C-chain of no more than 5 carbon atoms, preferably no more than 3 carbon atoms, more preferably no more than 2 carbon atoms;
c. transformation of said short chain intermediate to a carbon capture ingredient comprising a C-chain of at least 8 carbon atoms;
wherein any of steps a or b or c also introduce a non-aminofunctional organic solvent; and:
d. incorporating said carbon capture ingredient and non-aminofunctional organic solvent into a detergent composition.

The present invention relates to renewable liquid detergent compositions comprising captured carbon ingredients.

The use of fossil-based resources has the unavoidable consequence of releasing previously fixed CO2 into the atmosphere. Carbon dioxide (CO2) accounts for the majority of anthropogenic CO2 emissions to the atmosphere.

Carbon capture/usage accounts or and utilization involves the capture of carbon dioxide and its subsequent transformation to carbon based products. In this process carbon-containing gases such as carbon dioxide/carbon monoxide are captured/derived from the atmosphere or from exhaust gases from industrial processes such as steel processing, and then transformed to usable chemicals by e.g. catalytic processes, such as the Fischer-Tropsch process or by fermentation by C1-fixing microorganisms.

However, one problem with carbon capture is that impurities coming from the captured gases or in subsequent transformation processes where such gases may be converted to other chemicals may compromise the performance of certain end products. Whilst purification can remove impurities, this may not be effective in removing absolutely all impurities.

It has now been discovered that certain detergent compositions comprising external structuring systems (ESS) can be used with the carbon capture ingredients with entrained impurities e.g ethanol to produce products of with improved renewability but high performance.

Accordingly in one aspect, the invention provides a liquid detergent composition comprising an external structuring system for liquid and gel-form laundry detergents comprising by weight percentage (a) from about 2 to about 10 percent of crystals of a glyceride, preferably hydrogenated castor oil, having a melting temperature of from 40 degrees centigrade to 100 degrees C., the detergent composition comprising at least one ingredient derived from carbon capture.

The invention comprises aqueous laundry detergent compositions which are stabilized through the use of external structuring system(s) (ESS) comprising hydroxyl-containing stabilizers have been described. Hydrogenated castor oil (HCO) is a non-limiting example of a useful hydroxyl-containing stabilizer. HCO may be formulated into laundry detergent compositions using sodium-neutralized linear alkylbenzenesulfonate (NaLAS), a common laundry detergent anionic surfactant. It is believed that NaLAS acts as an emulsifier for the HCO structuring system. The acid form of LAS (HLAS) for use in such systems may be neutralized for example, with sodium hydroxide to form NaLAS. The structurant system may be prepared by forming, separately from the balance of the detergent composition, a melt of HCO in aqueous Na-neutralized LAS, which may then be stirred to form an emulsion of molten HCO. This emulsion may then be cooled to crystallize the HCO. Upon crystallization, an external structurant in the form of a premix may be yielded. The premix may then be added to the balance of a liquid laundry detergent composition in order to structure it. Alternatively, the structurant may be crystallized in-situ by mixing the molten emulsified HCO premix with the balance of the detergent composition and then cooling.

Alternatively, the HCO emulsifier may be an alkanolamine-neutralised anionic surfactant.

Preferably, the external structuring system further comprises by weight percentage:
(b) from about 2 to about 10 percent of an alkanolamine, preferably alkanolamine selected from: monoethanolamine; diethanolamine; triethanolamine, and mixtures thereof; and
(c) from about 5 to about 50 percent of the anion of an anionic surfactant; wherein said alkanolamine is present in an amount at least balancing the charge of the anion form of said anionic surfactant; and wherein said structuring system is free from any added inorganic cations.

The ESS may be provided as a premix. The premix is a product of forming a melt of crystallizable glyceride(s) including, but not limited to HCO, in aqueous at least partially lower alkanolamine-neutralized, preferably monoethanolamine-neutralized LAS. The crystallizable glyceride(s) melt is in the form of an emulsion or microemulsion, with the LAS acting as an emulsifier for the crystallizable glyceride(s). For purposes of clarity, it should be understood that “alkanolamine neutralized” means that the counter-ion of the anionic surfactant LAS is the cationic form or cation form of the alkanolamine. This alkanolamine is not acting as a solvent or as a buffer. The emulsion is cooled to crystallize the glyceride(s). This yields an external structurant in the form of an alkanolamine-containing, sodium-free crystallizable glyceride(s) premix, which can be shipped as an article of commerce, or can be directly added to the balance of a liquid laundry detergent composition. The resulting detergent compositions are surprisingly more physically stable and/or capable of containing higher levels of total cleaning surfactant, and/or are more capable of structuring or suspending particles of any benefit agents, e.g., encapsulated bleaches, perfume microcapsules, mica etc., than is possible when otherwise comparable sodium-neutralized LAS-emulsified crystallizable glyceride(s) is used. The ESS compositions herein, in short, have improved thickening power over otherwise similar ESS made using sodium-neutralized LAS-emulsified crystallizable glyceride(s).

Preferably, the ESS of the present invention may comprise the following by weight percentage: a. from about 2 to about 10 percent of crystals of a glyceride having a melting temperature of from 40 degrees centigrade to 100 degrees C.; b. from about 2 to about 10 percent of an alkanolamine; and c. from about 5 to about 50 percent of the anion of an anionic surfactant.

The alkanolamine is present in an amount at least balancing the charge of the anion form of said anionic surfactant and the structuring system is free from any added inorganic cations.

As used herein, the term “external structuring system” or ESS refers to a selected compound or mixture of compounds which provide structure to a detergent composition independently from, or extrinsic from, any structuring effect of the detersive surfactants of the composition. Structuring benefits include arriving at yield stresses suitable for suspending particles having a wide range of sizes and densities. ESS of use may have chemical identities set out in detail hereinafter.

To be noted, the present ESS make use of currently known individual raw materials. No new chemical entities, i.e., new chemical compounds, are produced. The invention relates to physical form modifications of the size and/or crystal habit of known chemical entities such as hydrogenated castor oil, and to processes associated therewith. Indeed, the avoidance of new chemical materials is one further advantage of the present invention.

Without wishing to be bound by theory, many external structurants are believed to operate by forming solid structures having particular morphologies in the detergent composition. These solid structures may take one or more physical forms. Non-limiting examples of typical physical or morphological forms include threads, needles, ribbons, rosettes and mixtures thereof. Without wishing to be bound by theory, it is believed that thread-like, ribbon-like, spindle-like or fibril-like structuring systems, that is to say structuring systems having non-spherical elongated particles, provide the most efficient structure in liquids. Consequently, in some embodiments, thread-like, ribbon-like, spindle-like or fibril-like structuring systems are preferred. It is further believed that external structurant systems comprising alkanolamine-neutralized, especially monoethanolamine-neutralized anionic surfactants, may contain, and provide in detergent compositions, a more complete fiber network than is present in an otherwise analogous composition in which a sodium neutralized anionic surfactant has been used, and may be more efficient in terms of surprisingly reducing the level of relatively poorly structuring spherical or rosette-like morphologies.

Further, in terms of underlying theory, but without intending to be limited thereby, the ESS systems of the invention possess higher thickening power than those wherein a sodium-neutralized anionic surfactant has been used, on account of the production therein of longer rodlike structures in the ESS as compared with the Na-anionic surfactant case. This is consistent with theory which predicts that the zero-shear viscosity of non-interacting hard rods in suspension scales with the third power of their length. See M. Doi, S. F. Edwards, Dynamics of rod-like macromolecules in concentrated solution, Part 1, Journal of Colloid Science 74 (1978) p. 560-570.

Further, in terms of underlying theory, but without intending to be limited thereby, the ESS systems of the invention provide higher yield stress or gel consistency at lower concentrations than do those involving Na-anionic surfactants. This is consistent with the theory which predicts that the minimum gel concentration scales with the inverse of length. See Bug, A. L. R.; Safran, S. A. Phys. Rev. 1986, 833, 4716. In simpler terms, in dispersions of objects in a solution, there exists a critical concentration, above which the system switches from a state having a number of discrete aggregates dispersed in the solution, to a state of forming a continuous network of aggregates. This transition causes the system to change from a viscoelastic liquid to a more “solid-like” gel. Above this threshold, the system starts to show a yield stress which is responsible for providing physical stabilization against macroscopic phase separation.

### Definitions

The following terms, as used herein, are defined below:

Articles such as “a” and “an” when used in a claim, are understood to mean one or more of what is claimed or described.

“Alkyl” means an unsubstituted or substituted saturated hydrocarbon chain having from 1 to 18 carbon atoms. The chain may be linear or branched.

“include”, “includes” and “including” are meant to be non-limiting. C1” refers to a one-carbon molecule, for example, CO, CO₂, CH₄, or CH₃ OH.

“C1-oxygenate” refers to a one-carbon molecule that also comprises at least one oxygen atom, for example, CO, CO₂, or CH₃ OH.

“carbon capture” means the capture of a C1 carbon, mostly, but not exclusively, as a gas.

Carbon is preferably captured from waste emissions (e.g. exhaust gases from industrial processes, known as “point sources”) or from the atmosphere. The term carbon capture excludes the direct use of fossil fuels e.g. crude oil, natural gas, coal or peat as the source of carbon. Such fossil-fuel based materials cannot be easily replenished or regrown (e.g., in contrast to carbon which is captured from the e.g. earth's atmosphere). However, carbon may be captured from the waste products arising from usage of fossil fuels, so for example carbon captured from the exhaust gases of the burning of fossil fuels in power generation. Conversely, captured carbon excludes direct use of the fossil fuel as a feedstock for the ingredient. For example, refined crude oil is currently a feedstock for the alkyl chains of many surfactants and other functional ingredients. This direct use of a fossil fuel as a feedstock is not carbon capture within the meaning intended here.

“captured carbon ingredient” means any ingredient comprising 1-100% wt (of the ingredient) carbon which is derived from carbon capture as defined herein.

Preferably the ingredient comprises at least 10% wt, more preferably at least 20% wt, even more preferably at least 30% wt, still more preferably at least 40% wt and most preferably at least 50% wt carbon which is derived from carbon capture. The maximum level is preferably 100% but it may be 90% or even 80%. Where it is less than 100%, it may be blended with ingredients where the carbon is from fossil fuel sources or any other source. The term “derived” may be used interchangeably with “obtained” or “made from”.

“ethoxylates” as described herein may not be single compounds as suggested by the formula but rather comprise a mixture of several homologs having varied polyalkylene oxide chain length and molecular weight. The total ethylene oxide units may vary and the resultant fatty alcohol ethoxylate may comprise some non-ethoxylated (unreacted) fatty alcohol.

“Detergent composition” in the context of this invention denotes formulated compositions intended for and capable of treating substrates as defined herein “detersive surfactant” in the context of this invention denotes a surfactant which provides a detersive (i.e. cleaning) effect to a substrate such as fabric treated as part of a domestic treatment e.g. laundering process.

“internal structuring” means that the detergent surfactants, which form a major class of laundering ingredients, are relied on for structuring effect. The present invention, in the opposite sense, aims at “external structuring” meaning structuring which relies on a nonsurfactant, e.g., crystallized glyceride(s) including, but not limited to, hydrogenated castor oil, to achieve the desired rheology and particle suspending power.

“ingredient” means any component in the detergent composition which can be derived from carbon capture, and includes, by way of example surfactants, such as LAS, SLES or nonionic surfactants such ethoxylated nonionic surfactants.

“impurity” means substances which are present in or with carbon capture ingredients for example ethanol or other non-aminofunctional organic solvent may be present in a carbon capture ingredient (which is not itself ethanol) as a bi-product of one or more transformation processes. Thus, when the ingredient is added to a detergent composition, the impurity is added automatically, without any additional steps.

“Limited solubility” means that no more than nine tenths of the formulated agent actually dissolves in the liquid composition. An advantage of crystallizable glyceride(s) such as hydrogenated castor oil as an external structurant is an extremely limited water solubility.

“Soluble” means that more than nine tenths of the formulated agent actually dissolves in the liquid composition at a temperature of 20 degrees centigrade “Premix” as used herein means a mixture of ingredients designed to be mixed with other ingredients, such as the balance of a liquid or gel-form laundry detergent, before marketing. A “premix” can itself be an article of commerce, and can be sold, for example in bulk containers, for later mixing with the balance of a laundry detergent at a remote location. One the other hand some premixes may directly be used for arriving at a complete detergent composition made in a single facility.

“Emulsion” otherwise specifically indicated, refers to macroscopic droplets, which are large enough to be seen using conventional optical microscopy, of hydrogenated castor oil and/or another triglyceride, in the structurant premix (ESS). The emulsion can involve liquid droplets or can involve solidified droplets, depending on the temperature. Hydrogenated castor oil is soluble to a very limited extent of about 0.8 percent by weight in the alkanolamine neutralized anionic surfactant containing premix, and as a result, microemulsions may also be present. However, under microemulsion conditions, the payload of crystallizable glyceride(s) such as hydrogenated castor oil in the ESS declines. Therefore, emulsions of crystallizable glyceride(s) such as hydrogenated castor oil comprising droplets easily visible using light microscopy are preferred over microemulsions in the present invention on account of their superior payload efficiency. This may appear counter-intuitive, in view of the thought that larger droplets of hydrogenated castor oil might lead to loss of efficiency in structuring.

“Aspect ratio” means the ratio of the largest dimension of a particle (1) to the smallest dimension of a particle (w), expressed as “I:w”. An aspect ratio may for example characterize a structurant crystal particle of crystallizable glyceride(s) such as hydrogenated castor oil. The aspect ratio of dispersions can be adequately characterized by TEM (transmission electron microscopy) or similar techniques, e.g., cryo-ESEM. In using such techniques in the present invention, the intent is to examine crystals of the hydrogenated castor oil, or, more generally, any equivalently crystallizable glyceride; hence it is preferred to conduct measurements with a minimum of artifact creation.

Artifacts can be created, for example, by evaporating solvent from the ESS so that surfactant crystals precipitate—these are not crystals of glyceride(s) such as hydrogenated castor oil for example. A high aspect ratio is desirable for the hydrogenated castor oil in the external structurants for use herein. Preferably the aspect ratio of crystals of hydrogenated castor oil in ESS and/or in detergents comprising is greater than 1:1, in other words the structurant crystals are elongated. In a preferred embodiment, the aspect ratio is at least 5:1. In a preferred embodiment the aspect ratio is from 5:1 to about 200:1, preferably from about 10:1 to about 100:1. In typical cases, the aspect ratio can be from 10:1 to 50:1.

“Needle Radius” means the short dimension (w) of an elongated particle, for example a structurant crystal particle of crystallizable glyceride(s) such as hydrogenated castor oil for example. A typical needle radius of a crystallized glyceride in the ESS and in the final detergent composition is at least about 20 nanometers (nm). In some embodiments, the needle radius is from about 20 to about 500 nm, more preferably from about 20 to about 150 nm. In typical cases the needle radius can be from about 50 to about 100 nm.

“Rosette” means a particle of crystallized structurant, e.g., of a glyceride such as hydrogenated castor oil for example, having a rosette-like appearance. Such particles can be readily seen by use of differential interference contrast microscopy, or other visual microscopy techniques. Rosettes can have an approximate diameter of 1-50 microns, more typically 2 to 20 microns, e.g., about 5 microns. Preferred ESS herein can be free from rosettes. Other preferred ESS herein may have a low proportion of rosettes to needle-like crystals. Without intending to be limited by theory, reducing the proportion of rosettes to needles improves the mass efficiency of the ESS.

“Hydrophilic Index”, (“HI”) of an anionic surfactant herein is as defined in WO 00/27958A1 (Reddy et al.). Low HI synthetic anionic surfactants are preferred herein.

“Comprising” as used herein means that various components, ingredients or steps can that be conjointly employed in practicing the present invention. Accordingly, the term “comprising” encompasses the more restrictive terms “consisting essentially of” and “consisting of. The present compositions can comprise, consist essentially of, or consist of any of the required and optional elements disclosed herein.

“essentially free” or “substantially free” of a component means that no amount of that component is deliberately incorporated into the composition.

Markush language as used herein encompasses mixtures of the individual Markush group members, unless otherwise indicated.

All percentages, ratios and proportions used herein are by weight percent of the composition, unless otherwise specified. All average values are calculated “by weight” of the composition or components thereof, unless otherwise expressly indicated. All numerical ranges disclosed herein, are meant to encompass each individual number within the range and to encompass any combination of the disclosed upper and lower limits of the ranges.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Carbon Capture Ingredients

The composition comprises at least one ingredient derived from carbon-capture. Any ingredient containing carbon may be derived from carbon capture for example a surfactant.

Carbon capture may involve capture of carbon-containing matter in any form (as a gas or a fluid or solid, preferably as a gas) as a by-product of an industrial process or from the atmosphere. The industrial process may be selected from the group containing; ferrous metal products manufacturing, non-ferrous products manufacturing, petroleum refining processes, gasification of biomass, gasification of coal, electric power production, carbon black production, ammonia production, methanol production and coke manufacturing, gas obtained from a steel mill or automobile exhaust fumes.

Carbon capture methods are known in the art and include biological separation, chemical separation, absorption, adsorption, gas separation membranes, diffusion, rectification or condensation or any combination thereof. Capturing CO₂ may involve removal of various impurities brought (e.g those output in gases from the above mentioned industrial processes) by known various purification methods however, as explained above, for lower cost products, these are often cost-prohibitive.

Processes that collect CO2 from the air may utilise solvents that either physically or chemically bind CO2 from the air. Solvents include strongly alkaline hydroxide solutions like, for example, sodium and potassium hydroxide. Hydroxide solutions in excess of 0.1 molarity can readily remove CO2 from air. Higher hydroxide concentrations are desirable and an efficient air contactor will use hydroxide solutions in excess of 1 molar. Sodium hydroxide is a particular convenient choice, but other solvents may also be of interest. Specifically, similar processes may be useful for organic amines as well. Examples of carbon capture include amine scrubbing in which CO2-containing exhaust gas passes through liquid amines to absorb most of the CO2. The carbon-rich gas is then pumped away.

Carbon capture may include post combustion capture whereby the CO2 is removed from “flue” gases after combustion of a carbon fuel, e.g. fossil fuel (e.g. coal, oil, natural gas) or a bio-fuel. Carbon capture may be pre-combustion, whereby the fossil fuel is partially oxidized, for instance in a gasifier. The CO from the resulting syngas (CO and H2) reacts with added steam (H₂O) and is shifted into CO2 and H2. The resulting CO2 can be captured from the exhaust stream. Capture may be by oxy-fuel combustion carbon capture, whereby a power plant burns fossil fuel in oxygen. This results in a gas mixture comprising mostly steam and CO2. The steam and carbon dioxide are separated by cooling and compressing the gas stream.

Carbon dioxide may be removed from the atmosphere or ambient air, by supplying a CO2 absorbing liquid. The CO2 is then recovered from the liquid for use.

Electrochemical methods for carbon dioxide recovery from alkaline solvents for carbon dioxide capture from air may be used as in US2011108421. Alternatively, the captured CO2 may be captured as a solid or liquid for example as a bicarbonate, carbonate or hydroxide from which the CO2 is extracted using well know chemistries.

The carbon may be temporarily stored before usage or used directly. Captured carbon undergoes a process of transformation to chemical products as follows:

CO2 and water can be reduced to CO and H2 creating synthesis gas which can be used as a feedstock for e.g. Fischer Tropsch (FT) reactions (also called Gas to Liquids (GTL) reactions), which involve converting a mixture of hydrogen and CO over a FT catalyst into hydrocarbons e.g. paraffinic or olefin hydrocarbons. Carbon monoxide feedstock may be captured as CO or carbon dioxide may be converted into carbon monoxide by a reverse water gas shift reaction.

Gasification can be another source of syn gas by the conversion of e.g. biomass waste into carbon monoxide, hydrogen and carbon dioxide.

CO2 or CO containing gases may be transformed to chemicals such as short-chain alcohols e.g. ethanol via known chemistries or carbon capture fermentation e.g. C1-fixing fermentation processes involving e.g. acetogenic bacterium. The ability of micro-organisms to grow on CO as a sole carbon source was first discovered in 1903. This was later determined to be a property of organisms that use the acetyl coenzyme A (acetyl CoA) biochemical pathway of autotrophic growth (also known as the Woods-Ljungdahl pathway and the carbon monoxide dehydrogenase/acetyl CoA synthase (CODH/ACS) pathway). A large number of anaerobic organisms including carboxydotrophic, photosynthetic, methanogenic and acetogenic organisms have been shown to metabolize CO to various end products, namely CO2, H2, methane, n-butanol, acetate and ethanol. Preferably anaerobic bacteria such as those from the genus Clostridium are used to produce ethanol from carbon monoxide, carbon dioxide and hydrogen via the acetyl CoA biochemical pathway. There are a variety of microorganisms that can be used in a fermentation processes, particularly preferred are anaerobic bacteria such as Clostridium ljungdahlii strain PETC or ERI2, which can be used to produce ethanol.

Short chain alcohols such as ethanol may be used as is, or subjected to chain growth reactions or converted to olefins (alkenes) e.g. ethylene and then either of these intermediates can be processed into various chemicals e.g. surfactants using well-known chemistries.

It is known to separate normal paraffins (generally, linear, aliphatic C9-C19 hydrocarbons) from crude oil (kerosene fraction) and then use different cuts (C chain length) to make various surfactants. For example LAS is made by dehydrogenation of n-paraffins (alkanes) comprising C10-C13 to olefins (alkenes) which is then reacted with benzene to form linear alkyl benzene (LAB), followed by sulphonation to form the LAS.

However, equally, the n-paraffin stock can also be from a FT reaction as described above.

Also, methanol can be synthesized from syn gas and used to manufacture all the components of surfactants using well known chemistries: alkenes/olefins, alkanes, longer chain alcohols, aromatics and ethylene (from which can be made ethylene oxide which is also an excellent starter chemical for various ingredients in detergent compositions).

Linear alcohols are a central step in obtaining both PAS and alkali-metal alkyl ether sulphate surfactants. SLES and other alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol.

US2003018086A (Sasol) discloses a process using synthesis gas for selectively producing linear alcohols, olefins and paraffins in a Fischer-Tropsch reactor. Shell Int. Research RD555023 discloses “Fischer-Tropsch derived feedstocks for the production of LAB and LAS. WO09058654 (Shell) discloses a process for producing secondary alcohol alkoxy sulfates from carbon monoxide and hydrogen.

Entrained impurities brought in from carbon capture include short chain alcohols including n-butanol or ethanol. Ethanol can be entrained from capture sources such as fermentation, coal gasification, etc. Whilst many formulations are not tolerant of the presence of ethanol, the inventors have found that detergent compositions of the invention are tolerant of such impurities to a significant level and so these do not require removing by expensive purification and huge savings can be made This is detailed below.

Exemplary ingredients of the detergent including the ESS, such as surfactants or ingredients which are additional to the ESS, which may be derived from carbon capture are described below.

External Structuring System

A suitable ESS is described in WO2011/031940 the contents of which, in particular as regards manufacture of the ESS are incorporated by reference. The ESS of the present invention comprise: (a) crystallizable glyceride(s); (b) alkanolamine; (c) anionic surfactant; (d) additional components; and (e) optional components. Each of these components is discussed in detail below.

(a) Crystallizable Glyceride(s).

Crystallizable glyceride(s) of use herein include “Hydrogenated castor oil” or “HCO”. HCO as used herein most generally can be any hydrogenated castor oil, provided that it is capable of crystallizing in the ESS premix. Castor oils may include glycerides, especially triglycerides, comprising Cio to C22 alkyl or alkenyl moieties which incorporate a hydroxyl group. Hydrogenation of castor oil to make HCO converts double bonds, which may be present in the starting oil as ricinoleyl moieties, to convert ricinoleyl moieties to saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited those selected from solid, molten and mixtures thereof. HCO is typically present in the ESS of the present invention at a level of from about 2 percent to about 10 percent, from about 3 percent to about 8 percent, or from about 4 percent to about 6 percent by weight of the structuring system. In some embodiments, the corresponding percentage of hydrogenated castor oil delivered into a finished laundry detergent product is below about 1.0 percent, typically from 0.1 percent to 0.8 percent.

Useful HCO may have the following characteristics: a melting point of from about 40 degrees centigrade to about 100 degrees centigrade, or from about 65 degrees centigrade to about 95 degrees C.; and/or Iodine value ranges of from 0 to about 5, from 0 to about 4, or from 0 to about 2.6. The melting point of HCO can measured using either ASTM D3418 or ISO 11357; both tests utilize DSC: Differential Scanning calorimetry. HCO of use in the present invention includes those that are commercially available. Non-limiting examples of commercially available HCO of use in the present invention include:

THIXCIN® from Rheox, Inc. Further examples of useful HCO may be found in U.S. Patent 5,340,390. The source of the castor oil for hydrogenation to form HCO can be of any suitable origin, such as from Brazil or India. In one suitable embodiment, castor oil is hydrogenated using a precious metal, e.g., palladium catalyst, and the hydrogenation temperature and pressure are controlled to optimize hydrogenation of the double bonds of the native castor oil while avoiding unacceptable levels of dehydroxylation.

The invention is not intended to be directed only to the use of hydrogenated castor oil. Any other suitable crystallizable glyceride(s) may be used. In one example, the structurant is substantially pure triglyceride of 12-hydroxystearic acid. This molecule represents the pure form of a fully hydrogenated triglyceride of 12-hydrox-9-cis-octadecenoic acid. In nature, the composition of castor oil is rather constant, but may vary somewhat. Likewise hydrogenation procedures may vary. Any other suitable equivalent materials, such as mixtures of triglycerides wherein at least 80 percent wt. is from castor oil, may be used. Exemplary equivalent materials comprise primarily, or consist essentially of, triglycerides; or comprise primarily, or consist essentially of, mixtures of diglycerides and triglycerides; or comprise primarily, or consist essentially of, mixtures of triglyerides with diglycerides and limited amounts, e.g., less than about 20 percent wt. of the glyceride mixtures, of monoglyerides; or comprise primarily, or consist essentially of, any of the foregoing glycerides with limited amounts, e.g., less than about 20 percent wt., of the corresponding acid hydrolysis product of any of said glycerides. A proviso in the above is that the major proportion, typically at least 80 percent wt, of any of said glycerides is chemically identical to glyceride of fully hydrogenated ricinoleic acid, i.e., glyceride of 12-hydroxystearic acid. It is for example well known in the art to modify hydrogenated castor oil such that in a given triglyceride, there will be two 12-hydroxystearic-moieties and one stearic moiety. Likewise it is envisioned that the hydrogenated castor oil may not be fully hydrogenated. In contrast, the invention excludes poly(oxyalkylated) castor oils when these fail the melting criteria.

Crystallizable glyceride(s) of use in the present invention may have a melting point of from about 40 degrees centigrade to about 100 degrees centigrade b. Alkanolamine Alkanolamine is an essential component the ESS of the present invention. Without wishing to be bound by theory, it is believed that alkanolamine reacts with the acid form anionic surfactant species to form an alkanolamine neutralized anionic surfactant. As such, alkanolamine can be introduced into the premix either by combining alkanolamine and acid-form anionic surfactant, e.g., HLAS in-situ in the premix, or by any other suitable means such as by separately neutralizing HLAS with alkanolamine and adding the neutral alkanolamine-LAS to the premix. However, in some embodiments it may be desirable that alkanolamine be present in the ESS of the invention in stoichiometric excess over the amount required to neutralize the acid form of the anionic surfactants. In such embodiments, the alkanolamine may serve the dual purpose of acting as part of the emulsifying surfactant and as a buffer. In some embodiments, the alkanolamine may be present at a level of from about 2 percent to about 10 percent, from about 3 percent to about 8 percent, or from about 3 percent to about 6 percent by weight of the structuring system. In some embodiments, the alkanoamine may be present at about 5 percent by weight of the structuring system.

In general, any suitable alkanolamine or mixture of alkanolamines may be of use in the present invention. Suitable alkanolamines may be selected from the lower alkanol mono-, di-, and trialkanolamines, such as monoethanolamine; diethanolamine or triethanolamine. Higher alkanolamines have higher molecular weight and may be less mass efficient for the present purposes. Mono- and di-alkanolamines are preferred for mass efficiency reasons. Monoethanolamine is particularly preferred, however an additional alkanolamine, such as triethanolamine, can be useful in certain embodiments as a buffer. Moreover it is envisioned that in some embodiments of the invention, alkanolamine salts of anionic surfactants other than the aliquots used in the ESS can be added separately to the final detergent formulation, for example for known purposes such as solvency, buffering, the management of chlorine in wash liquors, and/or for enzyme stabilization in laundry detergent products. c. Anionic Surfactant.

Anionic surfactant may be present in the ESS of the present invention at any suitable weight percentage of the total system. Without wishing to be bound by theory, it is believed that the anionic surfactant acts as an emulsifier of melts of HCO and similarly crystallizable glycerides. In the context of the external structuring system only (as opposed to in the context of a liquid detergent composition comprising a surfactant system), the following is true. As used herein “anionic surfactant” in preferred embodiments does not include soaps and fatty acids; they may be present in the final laundry detergent compositions, but in general, other than limited amounts of 12-hydroxystearic acid which may arise from limited hydrolysis of hydrogenated castor oil glycerides, are not deliberately included in the ESS. For overall formula accounting purposes, “soaps” and “fatty acids” are accounted as builders. Otherwise, any suitable anionic surfactant is of use in the ESS of present invention.

Preferred anionic surfactants herein, especially for the ESS, possess what is termed “low Krafft temperatures”. The term “Krafft temperature” as used herein is a term of art which is well-known to workers in the field of surfactant sciences. Krafft temperature is described by K. Shinoda in the text “Principles of Solution and Solubility”, translation in collaboration with Paul Becher, published by Marcel Dekker, Inc. 1978 at pages 160-161. “Krafft temperature” for the present purposes is measured by taking the sodium salt of an anionic surfactant having a single chainlength; and measuring the clearing temperature of a 1 wt percent solution of that surfactant. Alternative well-known art techniques include Differential Scanning calorimetry (DSC). See W. Kunz et al., Green Chem., 2008, Vol 10, pages 433-435. Preferred embodiments of the present invention external structuring systems employ anionic surfactants for which the corresponding sodium salt has a Krafft temperature below about 50 degrees centigrade, more preferably, below about 40 degrees centigrade, more preferably still, below about 30 degrees, or below about 20 degrees, or below 0 degrees centigrade.

Stated succinctly, the solubility of a surface active agent in water increases rather slowly with temperature up to that point, i.e., the Krafft temperature, at which the solubility evidences an extremely rapid rise. At a temperature of approximately 4 degrees centigrade above the Krafft temperature, a surfactant solution of almost any soluble anionic surfactant becomes a single, homogeneous phase. In general, the Krafft temperature of any given type of anionic surfactant will vary with the chain length of the hydrocarbyl group; this is due to the change in water solubility with the variation in the hydrophobic portion of the surfactant molecule.

Under circumstances where the anionic surfactant herein comprises a mixture of alkyl chain lengths, the Krafft temperature will not be a single point but, rather, will be denoted as a “Krafft boundary”. Such matters are well-known to those skilled in the science of surfactant/solution measurements. In any event, for such mixtures of anionic surfactants, what will be measured is the Krafft temperature of at least the longest chain-length surfactant present at a level of at least 10 percent by weight in such mixtures.

Krafft temperatures of single surfactant species are related to melting temperatures. The general intent herein, when using mixtures of anionic surfactants to emulsify hydrogenated castor oil or similarly crystallizable glycerides, is to obtain low melt temperatures of the collectivity of anionic surfactant molecules in the anionic surfactant mix.

A preferred group of anionic surfactants for inclusion in the ESS are synthetic anionic surfactants having a specified HI index, see the definition elsewhere in this specification. More particularly, for the ESS herein, it is preferred to use alkanolamine neutralized forms of a synthetic anionic nonsoap surfactant for which the corresponding Na-salt of the anionic surfactant has HI below 8, preferably below 6, more preferably, below 5. Without intending to be limited by theory, melting of anionic surfactant is majorly influenced by its hydrophobic group, while HI depends on a balanced ratio of hydrophilic and hydrophobic groups.

For example AE3S is undesirably hydrophilic for use in the ESS according to HI and has low Kraft point or melting temperature, which is desirable for use in the ESS premix; while LAS, especially LAS not having more than a limited amount of 2-phenyl isomers, is both desirably hydrophobic according to HI value for use in the ESS premix, and can be selected to have low melting temperatures (including molecules having low Krafft point), rendering its use preferred in the ESS premix. Note however, that when formulating the balance of the laundry detergent composition, it may be desirable in some embodiments to introduce separately from the ESS premix, an appreciable amount of AES-type surfactants for their known resistance to water hardness and good whiteness benefits.

In one embodiment the anionic surfactants used in the ESS can have pKa values of less than 7, although anionic surfactants having other pKa values may also be usable.

Non-limiting examples of suitable anionic surfactants of use herein include: Linear Alkyl Benzene Sulphonate (LAS), Alkyl Sulphates (AS), Alkyl Ethoxylated Sulphonates (AES) including 016/18 alkyl ether sulphates which may also be incorporated into the EES, Laureth Sulfates and mixtures thereof. In some embodiments, the anionic surfactant may be present in the external structuring system at a level of from about 5 percent to about 50 percent. Note however, that when using more than about 25 percent by weight of the ESS of an anionic surfactant, it is typically required to thin the surfactant using an organic solvent in addition to water. Suitable solvents are listed hereinafter.

Further, when selecting the anionic surfactant for the ESS, and an alkylbenzene sulfonate surfactant is chosen for this purpose, it may use any of (1) alkylbenzene sulfonates selected from HF-process derived linear alkylbenzenes and/or (2) mid-branched LAS (having varying amounts of methyl side-chains—see for example U.S. Pat. Nos. 6,306,817, 6,589,927, 6,583,096, 6,602,840, 6,514,926, 6,593,285. Other preferred LAS sources include (3) those available from Cepsa LAB, see WO 09/071709A1; and (4) those available from UOP LAB, see WO 08/055121A2. In contrast, LAS derived from DETAL™ process (UOP, LLC, Des Plaines, IL) process and/or LAS having high 2-phenyl content as taught by Huntsman (see for example U.S. Pat. No. 6,849,588 or US 2003/0096726 A 1 and having, for example, more than 70 percent or 80 percent 2-phenyl isomer content) are preferably avoided for use in the ESS, although they may be incorporated into the final laundry detergent compositions. Without intending to be limited by theory, excessive 2-phenyl isomer content leads to undesirably high melting temperatures of the LAS. As noted previously, the LAS may comprise captured carbon.

As noted previously, the anionic surfactant can be introduced into the ESS either as the acid form of the surfactant, and/or pre-neutralized with the alkanolamine. In no case is the anionic surfactant used as a sodium-neutralized form; more generally, the anionic surfactant is not used in the form of any monovalent or divalent inorganic cationic salt such as the sodium, potassium, lithium, magnesium, or calcium salts. Preferably, the ESS and the laundry detergents herein comprise less than about 5 percent, 2 percent or 1 percent of monovalent inorganic cations such as sodium or potassium. In a preferred embodiment, no (i.e., 0 percent) in total of monovalent and/or divalent inorganic metal ions whatsoever are added to the ESS, and no soap is deliberately added in making the ESS. In other words, the ESS is substantially free from monovalent and/or divalent inorganic metal ions.

Additional Components to the EES

Solvent to Reduce Viscosity in Liquid Carrier

In general the ESS herein comprises water, typically at levels of from 5 percent to 90 percent, preferably from 10 percent to 80 percent, more preferably from 30 percent to 70 percent. However organic non-aminofunctional organic solvents, typically consisting essentially of C, H and O (i.e., non-silicones and heteroatom-free) may also be present in the ESS as solvents to help control or reduce viscosity, especially during processing. The combination of water and non-aminofunctional organic solvent is sometimes referred to as a “liquid carrier”.

The non-aminofunctional organic solvents may be present when preparing the ESS premixes, or in the final detergent composition.

As mentioned above, entrained impurities brought in when adding ingredients derived from carbon capture can include certain short chain alcohols including n-butanol or ethanol.

This ingredient may be a part of the ESS or it may be an additional ingredient which are not part of the ESS. Because of this, the impurity may be added directly to the ESS or to the detergent composition or e.g. to any pre-mix which is added to the composition, either before or after addition of (also) the ESS.

Preferred organic non-aminofunctional solvents include monohydric alcohols, dihydric alcohols, polyhydric alcohols, glycerol, glycols, polyalkylene glycols such as polyethylene glycol, and mixtures thereof. Highly preferred are mixtures of solvents, especially mixtures of lower aliphatic alcohols such as ethanol, propanol, butanol, isopropanol, and/or diols such as 1,2-propanediol or 1,3-propanediol; or mixtures thereof with glycerol. Suitable alcohols especially include a C1-04 alcohol. Preferred are 1,2-propanediol and ethanol and mixtures thereof.

Any class or any proportion of the non-aminofunctional organic solvent may be derived from carbon capture as an “impurity”, being added as a result of adding the carbon-captured ingredient with which it is entrained. Whilst many other formulations are de-stabilized in the presence of such compounds, the compositions of the invention tolerate and even utilise them advantageously as non-aminofunctional organic solvents.

The level of non-aminofunctional organic solvent which is derived from carbon capture (as an impurity of the carbon captured ingredient) may be 0.1-100%, but is preferably 1% wt or more, more preferably 10% wt or more, even more preferably 30% wt or more, most preferably 50% wt or more by weight (as a weight percentage of the total non-aminofunctional organic solvent present in any formulation). The level may be as high as 100% wt. of the total non-aminofunctional organic solvent present in any formulation.

Ethanol as an impurity (of a carbon capture ingredient—may be present in the above liquid carriers. It's presence does not de-stabilize the formulation but acts to boost the solvent properties.

The level of ethanol which is obtained as an impurity of a carbon capture ingredient included in the detergent composition is preferably 0.01-100% wt, more preferably at least 1% wt, even more preferably at least 10% wt, even more preferably at least 30% wt, most preferably at least 50% wt (as a weight percentage of the total non-aminofunctional organic solvent present in the formulation). In some embodiments the level is 100% wt.

The level of ethanol which is obtained as an impurity of a carbon capture ingredient included in the detergent composition is preferably 0.01-100% wt, more preferably at least 1% wt, even more preferably at least 10% wt, even more preferably at least 30% wt, most preferably at least 50% wt (as a weight percentage of the total ethanol present in the non-aminofunctional solvent present in the composition). In some embodiments the level is 100% wt.

The level of ethanol which is obtained as an impurity of a carbon capture ingredient included in the detergent composition is preferably 0.01-100% wt, more preferably at least 1% wt, even more preferably at least 10% wt, even more preferably at least 30% wt, most preferably at least 50% wt (as a weight percentage of the total ethanol present in the composition). In some embodiments the level is 100% wt.

The invention includes embodiments in which propanediols are used but methanol is not used and ethanol is not added unless as an impurity from a carbon capture ingredient. In the final detergent compositions herein, liquid carrier is typically present at levels in the range of from about 0.1 percent to about 98 percent, preferably at least from about 10 percent to about 95 percent, more preferably from about 25 percent to about 75 percent by weight of the composition. In the ESS premixes, organic non-aminofunctional solvents may be present at levels of from 0 to about 30 weight percent, more typically from 0 about weight percent, and in some embodiments from about 1 to about 5 weight percent, of the ESS.

Accordingly in a further aspect the invention provides method of making a liquid detergent composition comprising an external structuring system (ESS) comprising by weight percentage (a) from about 2 to about 10 percent of crystals of a glyceride, preferably hydrogenated castor oil, having a melting temperature of from 40 degrees centigrade to 100 degrees C., said method comprising the step of including a carbon captured ingredient such that this step introduces a non-aminofunctional organic solvent. What is meant here is that when the carbon captured ingredient is added, so is the non-aminofunctional organic solvent added automatically because it is present with the ingredient, as an impurity.

In method of making a liquid detergent composition comprising an external structuring system (ESS) comprising by weight percentage (a) from about 2 to about 10 percent of crystals of a glyceride, preferably hydrogenated castor oil, having a melting temperature of from 40 degrees centigrade to 100 degrees C. said method comprising the steps of:
a. providing a C1 carbon feedstock
b. transformation of said C1 carbon feedstock to provide a short chain intermediate having a C-chain of no more than 5 carbon atoms, preferably no more than 3 carbon atoms, more preferably no more than 2 carbon atoms,
c. transformation of said short chain intermediate to a carbon capture ingredient comprising a C-chain of at least 8 carbon atoms;
wherein any of steps a or b or c also introduce a non-aminofunctional organic solvent; and:
d. incorporating said carbon capture ingredient and non-aminofunctional organic solvent into a detergent composition.

Again, what is meant here is the steps a or b or c introduce, as an impurity, the non-aminofunctional organic solvent which is then added automatically to the detergent composition when the ingredient is added.

Preferably step b. comprises carbon capture fermentation. Preferably this involves fermentation of C1 carbon, preferably by C1-fixing microorganisms such as bacteria to provide said short chain intermediates. The C1-fixing microorganisms include bacteria which may be anaerobic and include carboxydotrophic, photosynthetic, methagenic and acetogenic organisms. Bacteria from the genus Clostridium may be used. but particularly preferred are anaerobic bacteria such as Clostridium ljungdahlii strain PETC or ERI2, which can be used to produce ethanol (as the short chain intermediate).

The method may include the step of analysis of said carbon capture ingredient to provide an impurity profile for correspondence to the detergent composition and preferably the non-aminofunctional organic solvent.

Additional Anionic Surfactant

The ESS of the present invention may optionally contain surfactant in addition to anionic surfactants. In some embodiments, the systems may further comprise surfactant selected from: nonionic surfactant; cationic surfactant; amphoteric surfactant; zwitterionic surfactant; and mixtures thereof.

Buffer

The ESS of the invention may optionally contain a pH buffer. In some embodiments, the pH is maintained within the pH range of from about 5 to about 11, or from about 6 to about 9.5, or from about 7 to about 9. Without wishing to be bound by theory, it is believed that the buffer stabilizes the pH of the external structuring system thereby limiting any potential hydrolysis of the HCO structurant. However, buffer-free embodiments can be contemplated and when HCO hydrolyses, some 12-hydroxystearate may be formed, which has been described in the art as being capable of structuring. In certain preferred buffer-containing embodiments, the pH buffer does not introduce monovalent inorganic cations, such as sodium, in the structuring system. In some embodiments, the preferred buffer is the monethanolamine salt of boric acid. However embodiments are also contemplated in which the buffer is sodium-free and boron-free; or is free from any deliberately added sodium, boron or phosphorus. In some embodiments, the MEA neutralized boric acid may be present at a level of from about 0 percent to about percent, from about 0.5 percent to about 3 percent, or from about 0.75 percent to about 1 percent by weight of the structuring system.

As already noted, alkanolamines such as triethanolamine and/or other amines can be used as buffers; provided that alkanolamine is first provided in an amount sufficient for the primary structurant emulsifying purpose of neutralizing the acid form of anionic surfactants.

Water

ESS of the present invention may contain water. Water may form the balance of the present structuring systems after the weight percentage of all of the other ingredients are taken into account.

In some embodiments, the water may be present at a level of from about 5 percent to about 90 percent, from about 10 percent to about 40 percent, or from about 15 percent to about 35 percent by weight of the external structuring system. e. Optional Components

Preservative

Preservatives such as soluble preservatives may be added to the ESS or to the final detergent product so as to limit contamination by microorganisms. Such contamination can lead to colonies of bacteria and fungi capable of resulting in phase separation, unpleasant, e.g., rancid odors and the like. The use of a broad-spectrum preservative, which controls the growth of bacteria and fungi is preferred. Limited-spectrum preservatives, which are only effective on a single group of microorganisms may also be used, either in combination with a broad-spectrum material or in a “package” of limited-spectrum preservatives with additive activities. Depending on the circumstances of manufacturing and consumer use, it may also be desirable to use more than one broad-spectrum preservative to minimize the effects of any potential contamination.

The use of both biocidal materials, i.e. substances that kill or destroy bacteria and fungi, and biostatic preservatives, i.e. substances that regulate or retard the growth of microorganisms, may be indicated for this invention.

In order to minimize environmental waste and allow for the maximum window of formulation stability, it is preferred that preservatives that are effective at low levels be used. Typically, they will be used only at an effective amount. For the purposes of this disclosure, the term “effective amount” means a level sufficient to control microbial growth in the product for a specified period of time, i.e., two weeks, such that the stability and physical properties of it are not negatively affected. For most preservatives, an effective amount will be between about 0.00001 percent and about 0.5 percent of the total formula, based on weight. Obviously, however, the effective level will vary based on the material used, and one skilled in the art should be able to select an appropriate preservative and use level.

Preferred preservatives for the compositions of this invention include organic sulphur compounds, halogenated materials, cyclic organic nitrogen compounds, low molecular weight aldehydes, quaternary ammonium materials, dehydroacetic acid, phenyl and phenoxy compounds and mixtures thereof.

Examples of preferred preservatives for use in the compositions of the present invention include: a mixture of about 77 percent 5-chloro-2-methyl-4-isothiazolin-3-one and about 23 percent 2-methyl-4-isothiazolin-3-one, which is sold commercially as a 1.5 percent aqueous solution by Rohm and Haas (Philadelphia, PA) under the trade name Kathon; I,2-benzisothiazolin-3-one, which is sold commercially by Avecia (Wilmington, DE) as, for example, a 20 percent solution in dipropylene glycol sold under the trade name Proxel™ GXL sold by Arch Chemicals (Atlanta, GA); and a 95:5 mixture of 1,3 bis(hydroxymethyl)-5,5-dimethyl-2,4 imidazolidinedione and 3-butyl-2-iodopropynyl carbamate, which can be obtained, for example, as Glydant Plus from Lonza (Fair Lawn, NJ). The preservatives described above are generally only used at an effective amount to give product stability. It is conceivable, however, that they could also be used at higher levels in the compositions on this invention to provide a biostatic or antibacterial effect on the treated articles. A highly preferred preservative system is sold commercially as Acticide™ MBS and comprises the actives methyl-4-isothiazoline (MIT) and 1,2-benzisothizolin-3-one (BIT) in approximately equal proportions by weight and at a total concentration in the Acticide™ MBS of about 5 percent. The Acticide is formulated at levels of about 0.001 to 0.1 percent, more typically 0.01 to 0.1 percent by weight on a 100 percent active basis in the ESS premix.

non-aminofunctionalnon-aminofunctionalnon-aminofunctionalnon-aminofunctionalnon-aminofunctionalnon-aminofunctionalnon-aminofunctionalnon-aminofunctionalnon-aminofunctionalnon-aminofunctionalnon-aminofunctionalnon- aminofunctionalnon-aminofunctionalnon-aminofunctionalnon-aminofunctionalnon-aminofunctionalThickeners in addition to ESS

Polymeric thickeners known in the art, e.g., Carbopol™ from Lubrizol (Wickliffe, OH), acrylate copolymers such as those known as associative thickeners and the like may be used to supplement the ESS. These materials may be added either in the ESS premix, or separately into the final detergent composition. Additionally or alternatively known LMOG (low molecular weight organogellants) such as dibenzylidene sorbitol may be added to the compositions either in the ESS premix, or in the final detergent compositions. Suitable use levels are from about 0.01 percent to about 5 percent, or from about 0.1 to about 1 percent by weight of the final detergent composition.

Particulate Material

Either the ESS or the final detergent composition may further include particulate material such as suds suppressors, encapsulated sensitive ingredients, e.g., perfumes, bleaches and enzymes in encapsulated form; or aesthetic adjuncts such as pearlescent agents, pigment particles, mica or the like. Suitable use levels are from about 0.0001 percent to about 5 percent, or from about 0.1 percent to about 1 percent by weight of the final detergent composition. In embodiments of the invention it is found useful to incorporate certain particulate materials, e.g., mica for visual appearance benefits, directly into the ESS while formulating more sensitive particulate materials, e.g., encapsulated enzymes and/or bleaches, at a later point into the final detergent composition.

Method of Making External Structuring System

ESS of the present invention may be made using a method comprising the steps of: (a) preparing a first premix generally containing anionic surfactant and carrier fluid e.g., water and/or polyols; (b) forming a hot premix with inclusion of crystallizable glyceride(s) in the premix at a temperature of from about 50 degrees centigrade to about 150 degrees C.; (c) at least partially cooling or allowing to cool the product of steps (a) and (b) to provide the external structuring system (ESS) of the invention; and (d) optionally, adding a preservative to the external structuring system. These steps may be completed in the following order: “a” through “d”. However, it is noted that variations which result in thread-like ESS are also meant to be encompassed within the present invention, for example preservative may be included in step (a) rather than as a separate step (d). Each of the steps is discussed below. Once the ESS has been prepared, it may added to the balance of the detergent composition, typically with a temperature difference of no more than 20 degrees centigrade to 30 degrees centigrade between the ESS and the balance of the detergent composition; preferably the ESS and balance of the detergent are combined in the cold.

a. Preparing a Premix

In this step, a premix is made. In some embodiments, the premix comprises all of the components that are present in the external structuring system. Thus, the premix may be made by combining crystallizable glyceride(s); alkanolamine; anionic surfactant; water; lower alcohols; glycols; and any optional ingredient(s). Non-limiting examples of optional ingredients include preservatives, buffers surfactants other than the aforementioned anionic surfactant, aesthetic adjuncts such as perfumes or colorants, and the like.

b. Emulsifying the HC

In this step, the crystallizable glyceride(s) in the premix is emulsified, forming an emulsion, a mixture of an emulsion and a microemulsion, or a microemulsion. It is preferred to form an emulsion, for reasons set forth hereinbefore. This may be accomplished by increasing the temperature of the premix and/or by energy dissipation through the premix. The temperature may be increased using heat of neutralization of the anionic surfactant acid form on mixing with the alkanolamine; and/or through the application of heat from an external source.

The premix is heated to a temperature above room temperature. In some embodiments, the premix is heated to above the melting point of the crystallizable glyceride structuring agent, such as HCO for example. In some embodiments, the premix is heated to a temperature of from about 50 degrees centigrade to about 150 degrees centigrade, or from about 75 degrees centigrade to about 125 degrees centigrade, or from about 80 degrees centigrade to about 95 degrees centigrade

With energy dissipation, it is understood that any kind of device, delivering energy input to the premix can be applied to form the emulsion. Non-limiting examples of such devices may be selected from: static mixers and dynamic mixers (including all kinds of low shear and high shear mixers. In some embodiments, the emulsion can be formed in batch making system or in a semi continuous making system or a continuous making system.

c. Cooling the Premix

In this step, the premix is then cooled. Without wishing to be bound by theory, it is believed that during cooling, the liquid oil emulsion droplets de-wet as a result of surfactant adsorption, thereby promoting crystallization. Small crystals may nucleate from around the emulsion droplets during cooling. It is further believed that crystallization may be influenced by surfactant adsorption or cooling rate.

In some embodiments of the present invention, the external structuring system is cooled at a cooling rate of from about 0.1 degrees C./min to about 10 degrees C./min, from about 0.5 degrees C./min to about 1.5 degrees C./min, or from about 0.8 degrees C./min to about 1.2 degrees C./min. d. Addition of preservative.

As an optional step, at any point in the process sequence, a preservative as described hereinabove can be added to the embodiment. This can for example be useful if the premix is to be stored or shipped and needs to remain microbially uncontaminated over time.

General Shear Conditions

As has already been pointed out, the ESS herein can be manufactured using a range of equipment types and shear regimes. In one preferred embodiment, the process employs a relatively low shear regime, in which shear rates reach a maximum of from 100 to 500 s″¹, and the ESS experiences this shear maximum for a residence time under the highest shear condition of no more than 60 to 100 seconds (s). In practical terms, one process employs batch, pipe, pump and plate heat exchanger devices, and the maximum shear occurs in the plate heat exchanger stage used to cool the ESS; but the ESS passes quite seldom through this high shear area, for example only from about three to about five passes per production run.

Detergent Compositions

The ESS used in the present invention is incorporated into a detergent composition or components thereof as described below. The detergent composition can take any suitable form and may be selected from liquid laundry detergent, unit dose detergent and/or hard surface cleaning compositions. Preferably, the detergent is a laundry liquid composition.

Any suitable means of incorporating the ESS of the present invention into a detergent composition or components thereof may be utilized. One of skill in the art is capable of determining at what point in the detergent manufacturing process that the ESS should be incorporated. Since ESS of the present invention may be shear sensitive, it may be desirable in some embodiments to add the ESS to the detergent composition or components of thereof as late in the manufacturing process as possible. However, in some embodiments, it may be desirable to add the ESS earlier in the manufacturing process to stabilize any non-homogeneity prior to finishing the detergent in a late product differentiation process. Thus in some embodiments, the systems may be added via a continuous liquid process, whereas in other embodiments, the systems may be added via late product differentiation.

When incorporating ESS that are shear sensitive into other components to form a detergent composition, it may be advantageous to set certain operating parameters. For example, in some embodiments, the average shear rate utilized to incorporate the ESS may be from about 300 s″¹ to about 500 s″¹, from about 100 s″¹ to about 5000 s″¹, or from about 0.01 s″¹ to about 10000 s″¹. Instantaneous shear may be as high as from about 3000 s″¹ to about 5000 s″¹ for a short period of time. To define the rheology profile, a TA550 Rheometer, available from TA Instruments, is used to determine the flow curve of the compositions. The determination is performed at 20 degrees centigrade with a 4 cm flat plate measuring system set with a 500 micron gap. The determination is performed via programmed application of a shear rate continuous ramp (typically 0.05 s″¹ to 30 s″¹) over a period of time (3 minutes). These data are used to create a viscosity versus shear rate flow curve. The time needed to incorporate ESS into other components to form a detergent composition may be from about from about 1 s to about 120 s, from about 0.5 s to about 1200 s or from about 0.001 s to about 12000 s. b. Liquid Laundry Detergent Compositions.

In some embodiments, the present invention is directed to liquid laundry detergent compositions comprising the ESS of the present invention. The liquid laundry detergent compositions may be in any suitable form and may comprise any suitable components. Non-limiting examples of suitable components for use in the detergent are described in turn below.

The detergent may comprise a C16 and/or C18 alkyl based surfactant, as an alcohol ethoxylate or an alkyl ether sulphate and is typically available as a mixture with C16 and C18 alkyl chain length raw material.

Further Non-Ionic

Preferably, the composition comprises a non-ionic surfactant in addition to the surfactants described above. Preferably the composition comprises from 5 to 20% wt. non-ionic surfactant based on the total weight of composition including the 016/18 non-ionic surfactants as above described or any other nonionic surfactants, for example, polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of additional nonionic surfactant for use in the invention includes aliphatic C₁₂ to C₁₅ primary linear alcohol ethoxylates with an average of from 3 to 20, more preferably from 5 to 10 moles of ethylene oxide per mole of alcohol.

The alcohol ethoxylate may be provided in a single raw material component or by way of a mixture of components.

A further class of non-ionic surfactants include the alkyl poly glycosides. Rhamnolipids are another preferred additional surfactant.

Preferably, the weight ratio of total non-ionic surfactant to total alkyl ether sulphate surfactant (wt. non-ionic/wt. alkyl ether sulphate) is from 0.5 to 2, preferably from 0.7 to 1.5, most preferably 0.9 to 1.1.

Preferably, the weight ratio of total non-ionic surfactant to linear alkyl benzene sulphonate, where present, (wt. non-ionic/wt. linear alkyl benzene sulphonate) is from 0.1 to 2, preferably 0.3 to 1, most preferably 0.45 to 0.85.

Additional Anionic Surfactants

The composition preferably comprises an anionic surfactant (additional or as an alternative to any C16/18 alkyl ether sulphate as described above). Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, C12-C14 alkyl ether sulfates, alkaryl sulfonates, alpha-olefin sulfonates and mixtures thereof. The alkyl radicals preferably contain from 10 to 18 carbon atoms and may be unsaturated. The C12-C14 alkyl ether sulfates may contain from one to ten ethylene oxide or propylene oxide units per molecule, and preferably contain one to three ethylene oxide units per molecule. Alkyl ether sulfates are also called alcohol ether sulfates. Anionic surfactants are described in anionic surfactants, volume 56 of the Surfactant Science Seried (H. W. Stache editor) Dekker 1995.

Commonly used in laundry liquid compositions are C12-C14 alkyl ether sulfates having a straight or branched chain alkyl group having 12 to 14 carbon atoms and containing an average of 1 to 3E0 units per molecule. A preferred example is sodium lauryl ether sulfate (SLES) in which the predominantly C12 lauryl alkyl group has been ethoxylated with an average of 3E0 units per molecule.

The C12-C14 alkyl ether sulphate may be provided in a single raw material component or by way of a mixture of components.

The counterion for any of the anionic surfactants used in the compositions described herein is generally an alkali metal such as sodium or potassium; or an ammoniacal counterion such as ammonium, monoethanolamine, (MEA) diethanolamine (DEA) or triethanolamine (TEA). Mixtures of such counterions may also be employed.

The compositions according to the invention may preferably include alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant may be used, such as non-ethoxylated primary and secondary alkyl sulphates with an alkyl chain length of from 10 to 18. Mixtures of any of the above described materials may also be used.

Preferably, linear alkyl benzene sulphonate surfactant is present at from 1 to 20% wt., more preferably from 2 to 15% wt. of the composition, most preferably 8 to 12 wt. %.

Weight ratios are calculated for the protonated form of the surfactant.

The detergent composition with the EES may comprise 016/18 alcohol ethoxylate and C16/18 alkyl ether sulphate.

Preferably, the level of surfactant in the detergent composition is from 4 to 40 wt %.

Aqueous Liquid Carrier

The aqueous liquid carrier component of the liquid detergent products herein will generally comprise water present in concentrations ranging from about 0 percent to 90 percent, more preferably from about 5 percent to 70 percent, by weight of the composition.

Optional Detergent Composition Ingredients

The detergent compositions of the present invention can also include any number of additional optional ingredients. These include conventional laundry detergent composition components such as detersive builders, enzymes, enzyme stabilizers (such as propylene glycol, boric acid and/or borax), suds suppressors, soil suspending agents, soil release agents, other fabric care benefit agents, pH adjusting agents, chelating agents, smectite clays, solvents, hydrotropes and phase stabilizers, structuring agents, dye transfer inhibiting agents, optical brighteners, perfumes and coloring agents. The various optional detergent composition ingredients, if present in the compositions herein, should be utilized at concentrations conventionally employed to bring about their desired contribution to the composition or the laundering operation. Frequently, the total amount of such optional detergent composition ingredients can range from 2 percent to 50 percent, more preferably from 5 percent to 30 percent, by weight of the composition. A few of the optional ingredients which can be used are described in greater detail as follows: i) Organic Detergent Builders

The detergent compositions herein may also optionally contain low levels of an organic detergent builder material which serves to counteract the effects of calcium, or other ion, water hardness encountered during laundering/bleaching use of the compositions herein. Examples of such materials include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids C10-C22 fatty acids and citric acid. Other examples are organic phosphonate type sequestering agents such as those which have been sold by Monsanto under the Dequest tradename and alkanehydroxy phosphonates. Citrate salts and C12-C18 fatty acid soaps are highly preferred.

Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark. If utilized, organic builder materials will generally comprise from about 1 percent to 50 percent, more preferably from about 2 percent to 30 percent, most preferably from about 5 percent to 20 percent, by weight of the composition. ii) Detersive Enzymes

The liquid detergent compositions herein may comprise one or more detersive enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase, and known amylases, or combinations thereof. A preferred enzyme combination comprises a cocktail of conventional detersive enzymes like protease, lipase, cutinase and/or cellulase in conjunction with amylase. Detersive enzymes are described in greater detail in U.S. Pat. No. 6,579,839.

If employed, enzymes will normally be incorporated into the liquid detergent compositions herein at levels sufficient to provide up to 3 mg by weight, more typically from about 0.0001 mg to about 2.5 mg, of active enzyme per gram of the composition. Stated otherwise, the aqueous liquid detergent compositions herein can typically comprise from 0.001 percent to 5 percent, preferably from 0.005 percent to 3 percent by weight, of a commercial enzyme preparation. The activity of the commercial enzyme preparation is typically in the range of 10 to 50 mg active enzyme protein per gram of raw material. iii) Solvents, Hydrotropes and Phase Stabilizers.

The detergent compositions herein may also optionally contain low levels of materials which serve as phase stabilizers and/or co-solvents for the liquid compositions herein. Materials of this type include C1-C3 lower alkanols such as methanol, ethanol and/or propanol. Lower C1-C3 alkanolamines such as mono-, di- and triethanolamines can also be used, by themselves or in combination with the lower alkanols. If utilized, phase stabilizers/co-solvents can comprise from about 0.1 percent to 5.0 percent by weight of the compositions herein. iv) pH Control Agents.

The detergent compositions herein may also optionally contain low levels of materials which serve to adjust or maintain the pH of the aqueous detergent compositions herein at optimum levels. The pH of the compositions of this invention should range from about 6.0 to about 10.5, from about 7.0 to about 10.0, or from about 8.0 to about 8.5. Materials such as NaOH can be added to alter composition pH, if necessary, c. Unit Dose Detergent.

In some embodiments of the present invention, the liquid detergent compositions are packaged in a unit dose pouch, wherein the pouch is made of a water soluble film material, such as a polyvinyl alcohol. In some embodiments, the unit dose pouch comprises a single or multicompartment pouch where the present liquid detergent composition can be used in conjunction with any other conventional powder or liquid detergent composition. Examples of suitable pouches and water soluble film materials are provided in U.S. Pat. Nos. 6,881,713, 6,815,410, and 7,125,828. The pouch is preferably made of a film material which is soluble or dispersible in water, and has a water-solubility of at least 50 percent, preferably at least 75 percent or even at least 95 percent, as measured by the method set out here after using a glass-filter with a maximum pore size of 20 microns:

50 grams plus or minus 0.1 gram of pouch material is added in a pre-weighed 400 ml beaker and 245 ml plus or minus 1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred pouch materials are polymeric materials, preferably polymers which are formed into a film or sheet. The pouch material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60 percent. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35 percent by weight polylactide and about 65 percent to 99 percent by weight polyvinyl alcohol. Preferred for use herein are polymers which are from about 60 percent to about 98 percent hydrolysed, preferably about 80 percent to about 90 percent hydrolysed, to improve the dissolution characteristics of the material.

Naturally, different film material and/or films of different thickness may be employed in making the compartments of the present invention. A benefit in selecting different films is that the resulting compartments may exhibit different solubility or release characteristics.

Most preferred pouch materials are PVA films known under the trade reference MonoSol M8630, as sold by Chris-Craft Industrial Products (Gary, IN), and PVA films of corresponding solubility and deformability characteristics. Other films suitable for use herein include films known under the trade reference PT film or the K-series of films supplied by Aicello (Koshikawa, Japan), or VF-HP film supplied by Kuraray (Tokyo, Japan).

The pouch material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

For reasons of deformability pouches or pouch compartments containing a component which is liquid will preferably contain an air bubble having a volume of up to about 50 percent, preferably up to about 40 percent, more preferably up to about 30 percent, more preferably up to about 20 percent, more preferably up to about 10 percent of the volume space of said compartment.

Unit dose pouches comprising liquid detergent compositions according to the present invention may be made using any suitable means. Non-limiting examples of such means are described in the patents listed above.

The pouch is preferably made of a film material which is soluble or dispersible in water, and has a water-solubility of at least 50 percent, preferably at least 75 percent or even at least 95 percent, as measured by the method set out here after using a glass-filter with a maximum pore size of 20 microns:

50 grams plus or minus 0.1 gram of pouch material is added in a pre-weighed 400 ml beaker and 245 ml plus or minus 1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). The percentage solubility or dispersability can then be calculated. d. Hard Surface Cleaning Compositions.

In some embodiments, the ESS may be utilized in liquid hard surface cleaning compositions. Such compositions include, but are not limited to, forms selected from gels, pastes, thickened liquid compositions as well as compositions having a water-like viscosity. A preferred liquid hard surface cleaning composition herein is an aqueous, liquid hard surface cleaning composition and therefore, preferably comprises water more preferably in an amount of from 50 percent to 98 percent, even more preferably of from 75 percent to 97 percent and most preferably 80 percent to 97 percent by weight of the total composition.

### EXAMPLES

Example 1 is an example of a liquid detergent composition according to the invention, wherein a premix comprising 4 percent HCO, 16 percent Linear Alkylbenzene Sulfonic acid neutralized by 3.1 percent Monoethanolamine (MEA), and water up to 100 parts is made and then added at 18.75 percent in a HDL comprising the rest of the ingredients, to give the detergent composition 1 in Table I.

TABLE 1

| Ingredient | % wt. |
|---|---|
| Linear Alkyl benzene sulphonic acid¹ | 15 |
| C12-14 alkyl ethoxy 3 sulphate MEA salt | 10 |
| C12-14 alkyl 7 ethoxylate | 10 |
| C12-18 fatty acid | 10 |
| citric acid | 2 |
| Soil suspending Alkoxylated polyalkylenimine polymer² | 3 |
| Hydroxyethane diphosphonic acid | 1.6 |
| Fluorescer | 0.2 |
| 1,2-propanediol | 6.2 |
| Ethanol | 1.5 |
| Hydrogenated Castor Oil | 0.75 |
| Boric acid | 0.5 |
| Perfume | 1.7 |
| Monoethanolamine | to pH 8 |
| Protease | 1.5 |
| Amylase | 0.1 |
| Mannanase | 0.1 |
| Cellulase | 0.1 |
| Xyloglucanase | 0.1 |
| Pectate Lyase | 0.1 |
| Water | to 100 |

¹Weight percentage of Linear Alkylbenzene sulfonic acid includes that which added to the composition via the premix

Any of the surfactants may be derived from carbon capture.

1. A liquid detergent composition comprising an external structuring system (ESS) for liquid and gel-form laundry detergents comprising by weight percentage (a) from about 2 to about 10 percent of crystals of a glyceride, preferably hydrogenated castor oil, having a melting temperature of from 40 degrees centigrade to 100 degrees C., the composition comprising at least one ingredient derived from carbon capture.

2. A liquid detergent composition according to claim 1 further comprising a non-aminofunctional organic solvent derived from carbon capture as an impurity of the carbon captured ingredient.

3. A liquid detergent composition according to claim 1 wherein the level of non-aminofunctional organic solvent which is derived from carbon capture (as an impurity of the carbon captured ingredient) is 0.1-100%, preferably 1% wt or more, more preferably 10% wt or more, even more preferably 30% wt or more, most preferably 50% wt or more by weight (as a weight percentage of the total non-aminofunctional organic solvent present in any formulation).

4. A liquid detergent composition according to claim 1 wherein the impurity is ethanol or butanol.

5. A liquid detergent composition according to claim 1 wherein the ESS further comprises by weight percentage:
(b) from about 2 to about 10 percent of an alkanolamine, preferably alkanolamine selected from: monoethanolamine; diethanolamine; triethanolamine, and mixtures thereof; and
(c) from about 5 to about 50 percent of the anion of an anionic surfactant; wherein said alkanolamine is present in an amount at least balancing the charge of the anion form of said anionic surfactant; and wherein said ESS is free from any added inorganic cations.

6. A detergent composition of claim 1 wherein said detergent composition, wherein said detergent composition is a liquid enclosed in water-soluble film.

7. A detergent composition of claim 1 wherein said detergent composition is a detergent selected from a hard surface cleaning composition and a liquid laundry detergent composition.

8. A liquid detergent composition according to claim 1 wherein the ingredient derived from carbon capture comprises a surfactant.

9. A liquid detergent composition according to claim 1 wherein the at least one ingredient derived from carbon capture is an ingredient of the ESS.

10. A liquid detergent composition according to claim 1 wherein the at least one ingredient derived from carbon capture is an ingredient additional to the ESS.

11. A method of making a liquid detergent composition comprising an external structuring system (ESS) comprising by weight percentage (a) from about 2 to about 10 percent of crystals of a glyceride, preferably hydrogenated castor oil, having a melting temperature of from 40 degrees centigrade to 100 degrees C., said method comprising the step of including a carbon captured ingredient such that this step introduces a non-aminofunctional organic solvent.

12. A method of making a liquid detergent composition comprising an external structuring system (ESS) comprising by weight percentage (a) from about 2 to about 10 percent of crystals of a glyceride, preferably hydrogenated castor oil, having a melting temperature of from 40 degrees centigrade to 100 degrees C. said method comprising the steps of:
a. providing a C1 carbon feedstock
b. transformation of said C1 carbon feedstock to provide a short chain intermediate having a C-chain of no more than 5 carbon atoms, preferably no more than 3 carbon atoms, more preferably no more than 2 carbon atoms;
c. transformation of said short chain intermediate to a carbon capture ingredient comprising a C-chain of at least 8 carbon atoms;
wherein any of steps a or b or c also introduce a non-aminofunctional organic solvent; and:
d. incorporating said carbon capture ingredient and non-aminofunctional organic solvent into a detergent composition.

13. A method according to claim 11 wherein the at least one ingredient derived from carbon capture is an ingredient of the ESS.

14. A method according to claim 11 wherein the at least one ingredient derived from carbon capture is an ingredient additional to the ESS.

15. A method according to claim 11 wherein the at least one ingredient derived from carbon capture is a surfactant.

16. A method according to claim 12 wherein the at least one ingredient derived from carbon capture is an ingredient of the ESS.

17. A method according to claim 12 wherein the at least one ingredient derived from carbon capture is an ingredient additional to the ESS.

18. A method according to claim 12 wherein the at least one ingredient derived from carbon capture is a surfactant.
